(19) United States
(12) Patent Application Publication
(10) Pub. No.: US 2009/0125990 A1
(43) Pub. Date: May 14, 2009

(54) WIRELESS E MAIL CONNECTIVITY

(76) Inventor: BRAM JAN STREEFLAND, ETTEN-LEUR (NL)

Correspondence Address: LAW OFFICES OF WILLIAM H. HOLT, 12311 HARBOR DRIVE, WOODBRIDGE, VA, 22192, US

(21) Appl. No.: 11/939,447

(22) Filed: Nov. 13, 2007

(51) Int. Cl. G06F 21/00

(52) U.S. Cl. 726/5

(57) ABSTRACT

A method, system and software enable e-mails to be sent from a mobile wireless device on which an email client application is installed while roaming on any wireless IP network, without limitation due to the home ISP restrictions. This involves the steps of: automatically or manually configuring the roaming user's email client to deliver email locally on the mobile device; so intercepting emails sent by the e-mail client; determining if the currently connected network is on a predefined list; avoiding outgoing email server flooding; routing of the email through a dedicated secure SMTP server with SMTP authentication and encryption; and associating wireless network log-in credentials with SMTP authentication credentials in a secure and hidden manner.

The present invention relates to the field of mobile wireless network connectivity in a roaming context. More specifically it relates to software connectivity components providing email services (SMTP) to users connected to wireless networks, and to an email system.

### BACKGROUND OF THE INVENTION

In today's context of worldwide wireless network connectivity, it becomes more and more difficult for a non-technical user to perform basic operations such as sending an email when not connected to his preferred home or corporate network. Internet service providers (ISP) provide access to user's email accounts, and therefore access to their email servers (SMTP) for sending out emails. However most ISPs have encountered spam flooding their servers, and therefore have been forced to restrict access to avoid this type of traffic. Consequently most ISPs do not allow those who are not their regular subscribers to use their outgoing email services. So although is always possible to read email from incoming email servers (e.g. using POP/IMAP/Webmail) regardless of the network currently connected to, in most cases it is impossible to send emails through the ISP outgoing email server (SMTP) if a user is not connected to a network to which he is a subscriber or regular user.

It may nevertheless be possible to use the Web based interface (Webmail) to send emails, but this limits the user's productivity and provides a limited set of features and functionalities. Consequently, as the majority of users today get online primarily in order to send and receive emails so as to exchange personal or business information, this restriction imposed by ISPs limits the advantages of using a public access point for connecting to the Internet. There is currently no transparent and simple solution for the user to send emails seamlessly when roaming on a different network from his preferred home or corporate network, apart from using a corporate VPN that has to be set up by his company's IT department at a high cost (implying other corporate security considerations).

### SUMMARY OF THE INVENTION

In order to ease the email sending issue encountered daily by roaming users, the invention provides a wireless connection manager application embedding an intelligent and secure SMTP relay, using connection information and a secure public SMTP server to deliver emails to the internet.

This invention provides a transparent solution to users without opening the door to spam and unsolicited email flooding by combining connectivity based business logic together with standard anti-spam and email throttling mechanisms. This invention is targeted to service providers and virtual wireless operators, and offers to their subscribers the ability to roam on a worldwide network while keeping their existing email client's main functionalities (i.e. to send & receive emails), and without compromising existing anti-spam policies.

Hence the invention provides a method for sending e-mails with these features; it provides software for performing this method; and it provides a system that combines such software with a wireless ISP aggregator network. It should be appreciated that the invention is not dependent upon a particular protocol for communicating information between a mobile device and a wireless network; for example it would be applicable to both a wi-fi network (based on the IEEE 802.11 standard) or to a WiMAX network (based on the IEEE 802.16 standard).

Details of the solutions are provided in the accompanying drawings and in the detailed description which follows; these are given by way of example only.

### BRIEF DESCRIPTION OF THE DRAWINGS

For a clear understanding of the invention, drawings are provided to support the detailed description of the architecture, design and features. Included in the drawings are the following figures:

FIG. 1 is a network diagram illustrating the basic wireless session configuration showing the different domains with their main actors participating in the present invention;

FIG. 2 is a software block diagram showing the components of a wireless connection manager 600 responsible for the implementation of the present invention as installed on a mobile wireless device 110; internal communications between the components as well as external communications with other key systems are depicted by arrows;

FIG. 3 is a block diagram illustrating the flow chart of an embodiment of the invention; and

FIG. 4 is a software block diagram showing the components responsible for the update of the wireless connection manager 600 encrypted configuration file 650 from a secure update server 360 of the WISP aggregator 300.

### DETAILED DESCRIPTION

In general, the invention features a system capable of sending emails using a standard email client while roaming on any wireless network using an embedded intelligent SMTP relay in conjunction with network connection information as well as standard anti-spam and email throttling features. The description will first present the scenario of the invention, then the process implementing the invention and finally some security aspects that will help understanding of the invention.

### Scenario

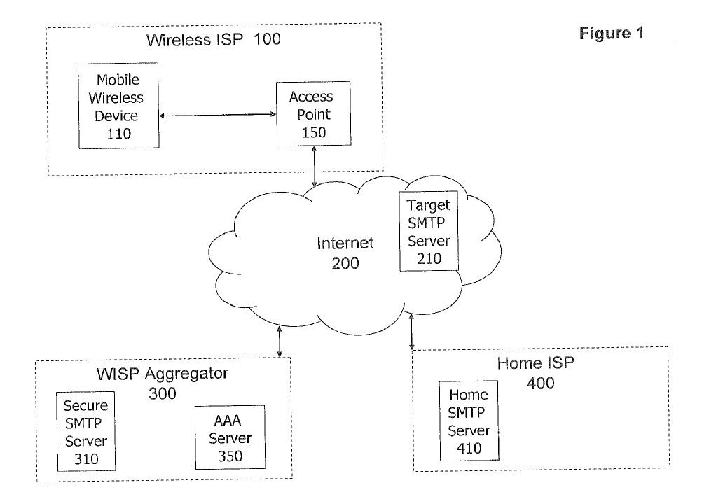

FIG. 1 presents the different actors taking part in the email session of a user while roaming onto a wireless domain, and will explain the context of the invention by description of a typical scenario.

A roaming user equipped with a mobile wireless device 110 is connected to the internet 200 through an access point 150 belonging to a wireless ISP 100. The roaming user wishes to send an email to an address managed by the target SMTP server 210, meaning that the target SMTP server 210 is declared as the email recipient mail transport agent (MTA). In a standard situation, the roaming user's email client is configured to send email using his home SMTP server 410 managed by his home ISP 400 that will then route the email to the target SMTP server 210.

For commercial and technical reasons (anti-spam, DOS attacks . . . ), most ISPs today refuse to route and deliver emails sent by a subscriber not connected to the ISP's own network (e.g. by ADSL, dial-up, or cable . . . ). This is performed by checking the IP address of the mobile wireless device 110 against a list of IP addresses owned by the ISP. Therefore, the user will be unable to send emails, getting an error message from his home SMTP server 410 when trying to send the email message. At this stage, most users do not understand the problem, because they cannot send a email message while they are online although they can perform other standard activities such as browsing the internet; this generates a large number of technical support calls to the helpdesk of the wireless ISP 100 (wrong target) or the helpdesk of the home ISP 400 (rarely identified as the root cause).

The present invention is offered by a WISP aggregator 300 and is installed on the roaming user' mobile wireless device 110. With the invention installed on his mobile wireless device 110, the email sent by the roaming user is intercepted and then automatically routed to a secure SMTP server 310 hosted by the WISP aggregator 300, in a controlled and secure manner. The following section describes in detail how the invention intercepts the email on the mobile wireless device 110, applies the required verifications, and then routes the email securely to its target SMTP server 210 using the secure SMTP server 310 linked with an AAA server 350 of the WISP aggregator 300. (The AAA server 350 is a program that handles user requests for access to computer resources and provides an authentication, authorisation and accounting service.)

### Process

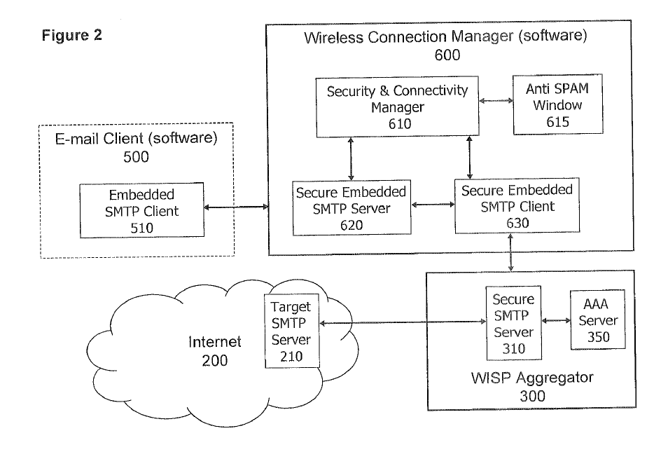

FIG. 2 presents an embodiment of the invention in a wireless connection manager 600 application; this application would be provided by the WISP aggregator 300. This drawing provides details of the internal components used for the invention, together with the data exchanged with external actors.

The wireless connection manager 600 is responsible for the reception of the email sent by the e-mail client 500. In order for the e-mail client 500 to send its SMTP traffic locally to the wireless connection manager 600 installed on the mobile device 110, it must be configured to do so. This configuration can be done manually in the e-mail client 500 by setting the SMTP server to the local loopback IP address (i.e. 127.0.0.1) on the TCP port 25, or automatically by enabling the SMTP service on the wireless connection manager 600 GUI. In the latter case, the wireless connection manager 600 will perform the required configuration changes in the e-mail client 500 installed on the mobile wireless device 110.

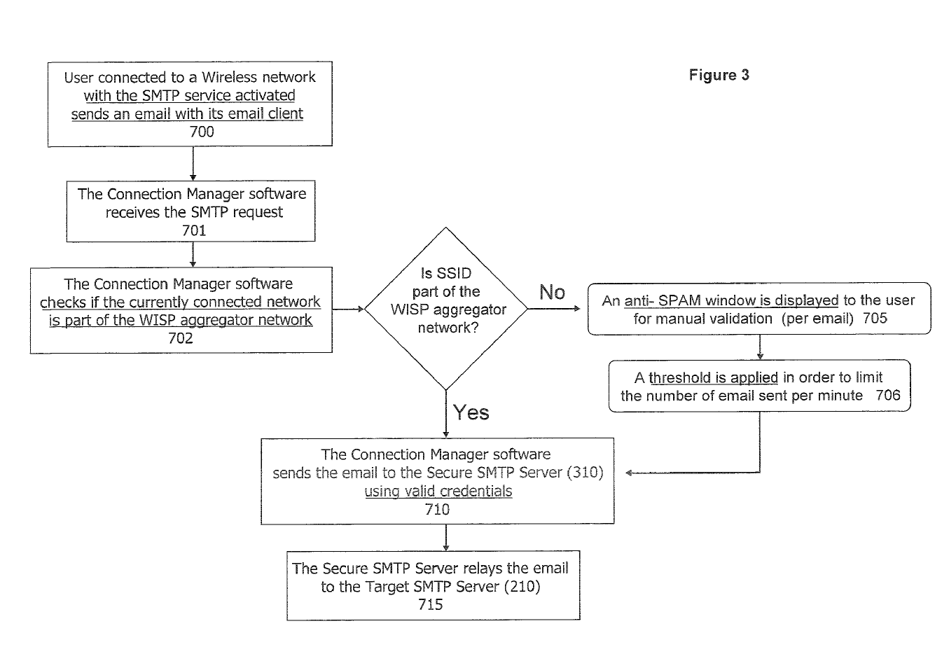

Once the e-mail client is configured to send all SMTP traffic (outgoing emails) to the TCP port 25 locally (on the loopback IP address, 127.0.0.1), all SMTP requests coming from the embedded SMTP client 510 of the e-mail client 500 will be received by a secure embedded SMTP server 620 of the wireless connection manager 600. For each outgoing email request 701 (see FIG. 3), the secure embedded SMTP server 620 will exchange data internally with a security and connectivity manager 610, in order to check the status of the currently connected wireless network 100 (see FIG. 1). This is based on the wireless network service set identifier (SSID) in the case of a WiFi network.

Referring also to FIG. 3, which shows the different steps of the decision process, if the currently connected wireless network 100 is part of the WISP aggregator 300 network (check 702 for matching SSID in a predefined list of SSIDs), then the email is transferred internally to the secure embedded SMTP client 630 that sends it 710 transparently without any restriction to a secure SMTP server 310 of the WISP aggregator 300, using an SMTP authentication method. In that case, user credentials used to log in to the WISP aggregator 300 network via the wireless ISP 100 access point 150 will be used for the SMTP authentication. The credentials are inserted automatically by the secure embedded SMTP client 630 and hidden from the user.

If the currently connected wireless network is not part of the WISP aggregator 300 network (check 702), then an anti-spam window 615 requiring manual validation (in this example: read and type a text string written in cursive font) is displayed to the user 705. If the user inputs the corresponding text string, then the email is transferred internally to the secure embedded SMTP client 630 with throttling limitation information 706 (i.e. the maximum number of emails permitted per minute). The secure embedded SMTP client 630 then sends the email 710, applying the throttling limitation, to the secure SMTP server 310 using the SMTP authentication method. In that case, static credentials are retrieved from the encrypted configuration file 650 of the wireless connection manager 600 and inserted automatically by the secure embedded SMTP client 630. The static credentials are therefore never shown to the user. If the user does not input the corresponding string when the anti-spam window 615 is displayed 705, the email is not sent and the SMTP session is terminated.

In order to validate the credentials used for the SMTP authentication method, the secure SMTP server 310 retrieves valid user credentials from the AAA server 350 of the WISP aggregator 300.

Once the email is successfully received by the secure SMTP server 310 (in both of the above cases), it is immediately routed to the target SMTP server 210 on the internet 200 for delivery 715. The email is accepted by the target SMTP server 210—because the secure SMTP server 310 is publicly declared with a fully qualified domain name on the internet 200.

### Security

All parameters required for the communications are contained in the wireless connection manager 600 encrypted configuration file 650 and can be updated remotely at any time by the WISP aggregator 300. These parameters are:
secure embedded SMTP server 620 TCP port
secure SMTP server 310 fully qualified domain name
secure SMTP server 310 TCP port
static SMTP username
static SMTP password
maximum number of emails per minute (when email throttling is applied)
SMTP delay between each email (when email throttling is applied)

The static credentials used for the SMTP authentication method are part of the wireless connection manager 600 encrypted configuration file 650, and are changed and communicated securely to the mobile wireless device 110 on a regular basis.

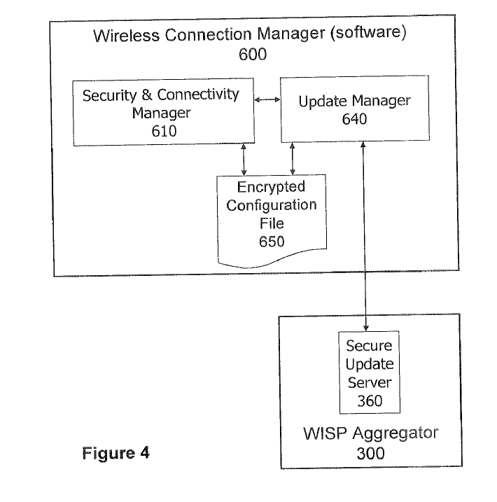

FIG. 4, to which reference is now made, depicts the update process for the encrypted configuration file 650, between the wireless connection manager 600 and a secure update server 360 of the WISP aggregator 300. Upon each successful connection of the wireless connection manager 600 to a network allowing access to the secure update server 360 of the WISP aggregator 300, the security and connectivity manager 610 requests an update of the encrypted configuration file 650 to the update manager 640. The update manager 640 then communicates with the secure update server 360 of the WISP aggregator 300 using a secured communication protocol (HTTPS) in order to verify if any parameter contained in the encrypted configuration file 650 has been changed. In the event that some or all of the parameters have been modified since the last check, data is sent back from the secure update server 360 to the update manager 640 over the internet 200, using encryption in order to prevent the information from being intercepted.

The updated parameters are then received by the update manager 640 and then encrypted into the modified encrypted configuration file 650. The update manager 640 then notifies the security and connectivity manager 610 that the encrypted configuration file 650 has been updated in order for new parameters to be taken into account for the next email session.

Only the e-mail client 500 located on the same mobile wireless device 110 as the wireless connection manager 600 is allowed to send emails through the secure embedded SMTP server 630 (i.e. using the same IP address). This is to prevent a mobile wireless device 110 equipped with the invention and connected to a valid WISP aggregator 300 network from being used as an SMTP relay for a large network of connected devices.

Encrypted connection (e.g. SSL) between the secure embedded SMTP client 630 and the secure SMTP server 310 are used in order to increase the security of the exchanged data.

I claim:

1. A method for sending email from a mobile wireless device on which an email client application is installed while roaming on any wireless IP network, without limitation due to the home ISP restrictions, the method comprising the steps of:
automatically or manually configuring the roaming user's email client to deliver email locally on the mobile device;
intercepting emails sent by the e-mail client;
applying an algorithm to determine if the currently connected network is on a predefined list;
applying an anti-spam mechanism and email throttling, at least if the currently connected network is not on the predefined list, to avoid outgoing email server flooding;
routing of the email through a dedicated secure SMTP server with intelligent SMTP authentication and SSL encryption; and
associating wireless network log-in credentials with SMTP authentication credentials in a secure and hidden manner.

2. A method as claimed in claim 1 wherein said steps are performed by an integrated wireless connection manager application installed on the mobile device used by the roaming user, and that at least the intercepting, determining, routing and associating steps are hidden from the user.

3. A method as claimed in claim 1 also including the step of preventing transmission of e-mails by any other devices connected to a network to which the mobile device is also connected.

4. A method as claimed in claim 1 also including updating on a regular basis and in a secure manner all parameters used by the method.

5. Software for sending email from a mobile wireless device on which an email client application is installed while roaming on any wireless IP network, without limitation due to the home ISP restrictions, the software being arranged to manage the steps of:
automatically or manually configuring the roaming user's email client to deliver email locally on the mobile device;
intercepting emails sent by the e-mail client;
applying an algorithm to determine if the currently connected network is on a predefined list;
applying an anti-spam mechanism and email throttling, at least if the currently connected network is not on the predefined list, to avoid outgoing email server flooding;
routing of the email through a dedicated secure SMTP server with intelligent SMTP authentication and SSL encryption; and
associating wireless network log-in credentials with SMTP authentication credentials in a secure and hidden manner.

6. Software as claimed in claim 5 comprising an integrated wireless connection manager application installed on the mobile device used by the roaming user, and which operates in such a way that at least the intercepting, determining, routing and associating steps are hidden from the user.

7. Software as claimed in claim 5 which also prevents transmission of e-mails by any other devices connected to a network to which the mobile device is also connected.

8. Software as claimed in claim 5 also comprising means to update on a regular basis and in a secure manner all parameters used by the method.

9. A system enabling e-mails to be sent from a mobile wireless device on which an email client application is installed while roaming on any wireless IP network, without limitation due to the home ISP restrictions, the system comprising software installed on the mobile device for managing the steps of:
automatically or manually configuring the roaming user's email client to deliver email locally on the mobile device;
intercepting emails sent by the e-mail client;
applying an algorithm to determine if the currently connected network is on a predefined list;
applying an anti-spam mechanism and email throttling, at least if the currently connected network is not on the predefined list, to avoid outgoing email server flooding;
routing of the email through a dedicated secure SMTP server with intelligent SMTP authentication and SSL encryption; and
associating wireless network log-in credentials with SMTP authentication credentials in a secure and hidden manner;
and a wireless ISP aggregator network through which the e-mails are routed.

10. A system as claimed in claim 9 also including updating on a regular basis and in a secure manner all parameters required during operation, by transmission of updating data between the mobile wireless device and the aggregator network.
